(19) United States
(12) Patent Application Publication
(10) Pub. No.: US 2004/0019524 A1
(43) Pub. Date: Jan. 29, 2004

(54) Showcasing of products featured in entertainment productions

(76) Inventor: Aaron Timothy Marshall, Van Nuys, CA (US)

Correspondence Address: FULBRIGHT AND JAWORSKI L L P, PATENT DOCKETING 29TH FLOOR, 865 SOUTH FIGUEROA STREET, LOS ANGELES, CA, 900172576

(21) Appl. No.: 10/410,109

(22) Filed: Apr. 9, 2003

Related U.S. Application Data
(60) Provisional application No. 60/399,453, filed on Jul. 29, 2002.

(51) Int. Cl. G06F 17/60

(52) U.S. Cl. 705/14; 705/27

(57) ABSTRACT

A process for showcasing goods or services placed in an entertainment production includes the steps of identifying possible placement candidates, negotiating with sources of identified products, maximizing use of featured products in the production, and, after production has been completed, generating an interactive catalog of featured products linked both to the production and to the source. The source of the featured product may be charged a placement fee based at least in part on the prominence of the display in the catalog and/or on the extent to which the catalog is circulated to potential consumers of the featured products and services. The interactive catalog is preferably organized by scenes and/or product categories and contains hyperlinks to sources of the featured products, thus providing the viewer/consumer with the ability to easily discover, locate and purchase any products that have been showcased in a movie or television show using product placement.

This application is based on the Provisional Patent Application Serial No. 60/399,453, filed Jul. 29, 2002.

### BACKGROUND ART

It is common practice within the entertainment industry to review script and set design components to determine potential companies that can be approached for placing their products in the production as props.

A common agreement for placement of a product within a motion picture or television production involves a so-called Direct Trade. The manufacturer gives (or loans) the studio/production company the requested product, gratis and the studio/production company charges nothing to the manufacturer for putting the product in the movie. The manufacturer gets free product exposure, and the production company saves the cost of buying or renting the products. For particularly valuable products and services such as automobiles and air transportation, the source may also be mentioned in the closing credits.

For major motion picture productions, it is common to enter into a so-called Tie-In or Focused Advertising campaign with the manufacturer of a mass-marketed consumer product or service that is written into the script. The manufacturer promotes the movie together with the product, typically in television commercials, print ads, and radio ads. For a “blockbuster” this can amount to tens of millions of dollars worth of product exposure for the manufacturer, and an equivalent savings on promotion expenses for the producer. Such a Tie-in arrangement typically will include contractual guarantees giving the manufacturer limited control over the product placement, and the producer limited control over the advertising.

Typically, in the motion picture sector, product placement agreements are focused on the initial release, and there is no explicit provision for tie-ins with any subsequent re-release on video, DVD, and other ancillary markets.

In addition to product placement, manufacturers can become associated with a particular entertainment production and/or personality by entering into a longer term sponsorship contract resulting in exclusive product or manufacturer name recognition and a stronger brand name/product name presentation to the viewing audience. Such an arrangement is particularly common in the television sector.

A related practice is for star(s) of a motion picture or other entertainment production to interact with a name-brand product i.e., hold the product, wear the product, drink the product, drive the product, etc, in which case they will be a party to the product placement agreement.

The above-described conventional methods of employing product placement within entertainment productions such as motion pictures and television programming provide only limited exposure of the featured products and services. A particular product may be edited out of the final cut. Even if it is utilized in the release production, it may be overlooked by the audience, or not sufficiently identified by a specific brand or model name to facilitate subsequent purchase of the same item. Even if promoted concurrently in television commercials and print media advertisements, a product placed into a movie that has an invisible brand name, is in the background of a scene(s), and/or only has a moment on the screen will lack any motivational stimulus for the audience to care, or be aware, that the placed product is available for purchase. Tie-In and Focused Advertising is too expensive and too brief for maximum effectiveness, with the full thrust of the ad campaign taking place just before and during the theatrical opening of the movie, then being curtailed, or halted altogether, as interest in the movie declines. Television commercials are also limited in effectiveness, since the television audience is not particularly motivated to watch the commercial. Similarly, the television viewer may not watch credits identifying the placed goods or services by name, or the credits are so small and scroll up the screen so fast as to be unreadable.

Unlike television advertising, print ads in newspapers and magazines offer the benefit of allowing a consumer to consider buying a product in a relaxed reader-controlled manner; the ad stays in the reader's view until the reader turns the page. If the reader decides to, he or she can return to view the ad at any time. However, what diminishes the success of print ads in magazines/periodicals, for the purposes of motion picture/television product placement advertising, is that there is usually no direct connection between the entertainment production and the print ad. The potential consumers must not only have access to the magazine/periodical containing those ads, they must have the time and the desire to view the print advertisement while the entertainment experience in which the product was featured is still a vibrant memory. Once the next issue replaces the current issue, the current magazine/periodical, and the print ads contained therein, are left behind, either by being discarded or by being stored for archival purposes, and the print ads in the current issue have run their course and are no longer being viewed by potential consumers.

### SUMMARY OF THE INVENTION

In accordance with one aspect of the invention, a process for showcasing products (either goods or services) placed in an entertainment production includes the steps of identifying possible placement candidates, negotiating with sources of identified products, maximizing use of featured products in the production, and, after production has been completed, generating an interactive catalog of featured products linked both to the production and to the source.

The interactive catalog may be an additional source of revenue for the production company. In particular, the source of the featured product may be charged a placement fee based at least in part on the prominence of the display in the catalog and/or on the extent to which the catalog is circulated to potential consumers of the featured products and services.

In accordance with another aspect of the invention, an customized interactive catalog of featured products is developed for a particular entertainment production, which may be a movie, a television series, or the like. The interactive catalog is preferably organized by scenes and/or product categories and contains hyperlinks to sources of the featured products.

In accordance with yet another aspect of the invention, the hyperlink to the source of a particular featured product is uniquely identified with the catalog, and the placement fee is based at least in part on the number of identifiable sales or sales leads originated from the catalog.

In one embodiment, the interactive catalog is published and distributed with a subsequent re-release of a movie on DVD or other tangible medium. In another embodiment, the interactive catalog is published over the internet on a website promoting a particular movie, television show, or personality, and may be available even prior to the initial release of the production.

The interactive catalog offers the viewer/consumer the ability to easily discover, locate and purchase any products that have been showcased in a movie or television show using product placement. Such an interactive catalog allays the fears of manufacturers that the audience is overlooking their placed product, thus giving the creators and producers of the movies and television shows greater ability to offer placement of products to manufacturers, with attendant greater financial benefits to the creators/producers. It offers the manufacturer a clear, straightforward, reliable, purchase-motivating method of advertising product keyed to placement of a product within a movie or television program, in a form that can be readily adapted to international audiences and international markets.

### DRAWING FIGURES

FIG. 1 shows a WELCOME screen.

FIG. 2 shows a PRODUCT SELECTION menu with SELECT BY SCENE highlighted.

FIG. 3 shows a BY SCENE submenu.

FIG. 4 shows an IN SCENE screen.

FIG. 5 shows a PRODUCT INFORMATION screen.

FIG. 6 shows a PRODUCT SELECTION menu with SELECT BY CATEGORY highlighted.

FIG. 7 shows a BY CATEGORY submenu whereby the user is presented with a list of product categories available within the Catalog. The user has chosen BICYCLES.

FIG. 8 shows a WITHIN CATEGORY screen

FIG. 9 is a flowchart showing the connectivity from the Catalog to a linked PRODUCT WEBPAGE.

FIG. 10 is a flowchart showing the production of an INTERACTIVE PRODUCT PLACEMENT CATALOG

FIG. 11 is a flowchart showing the organization of an INTERACTIVE PRODUCT PLACEMENT CATALOG with the PRODUCT INFORMATION displays linked to the PRODUCT WEBPAGES

### DETAILED DESCRIPTION

In one embodiment, the Interactive Featured Product Catalog may be recorded on an optical read-only disc in a conventional DVD (“Digital Versatile Disc” format (preferably either as a separate track on the DVD containing a movie in which the Featured Products have been placed, or a separate disc that is shipped with the movie), and is playable on a dedicated DVD player or computer equipped to read DVD-ROM's. In other embodiments, it is stored on a conventional magnetic storage medium such as the hard drive of a personal computer or cached in one or more networked servers, and is accessible by a home computer. The user can utilize either the DVD player controller or computer mouse to point to each button, and click the ENTER button or mouse button, respectively.

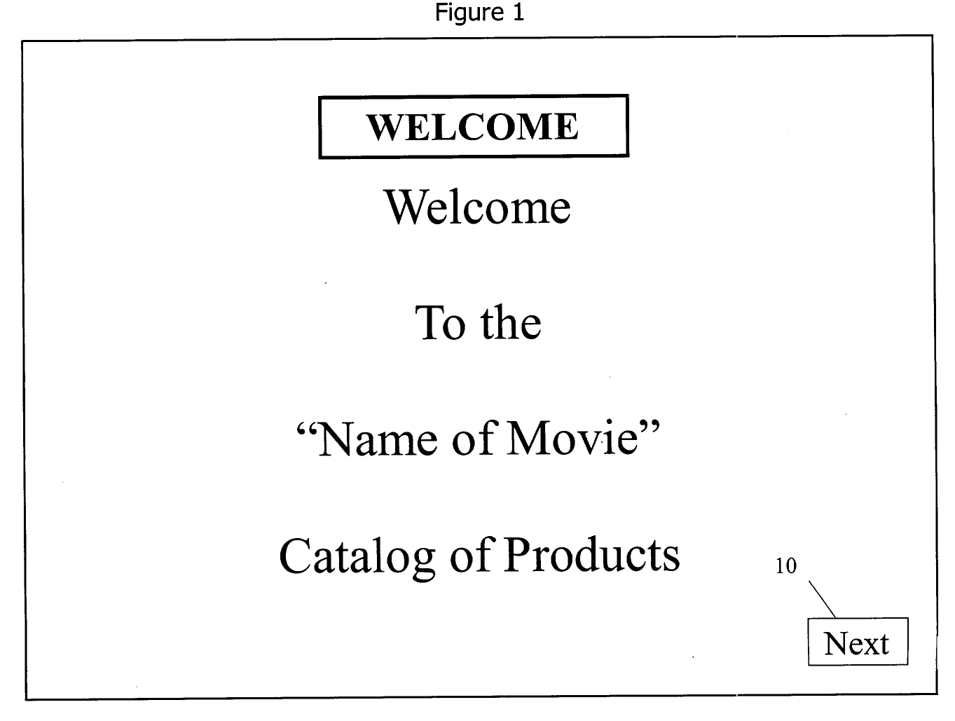

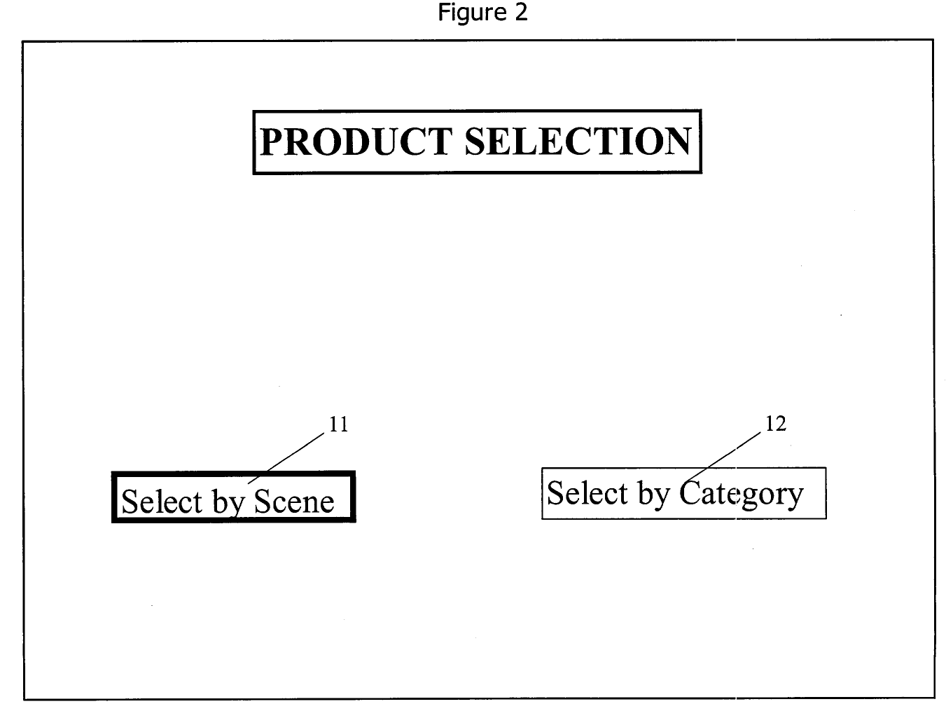

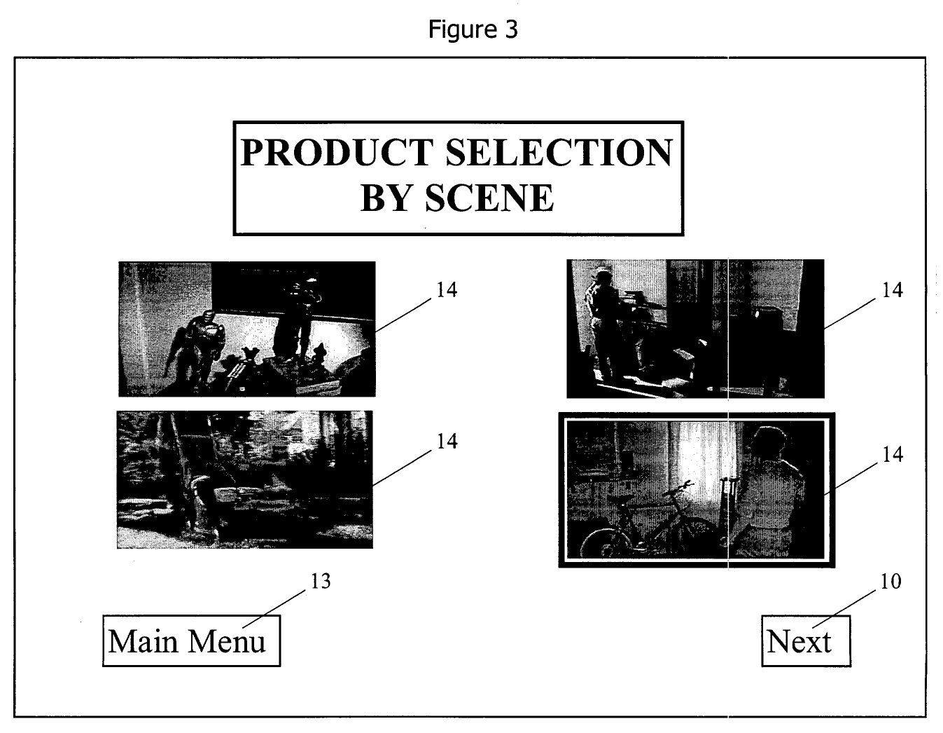

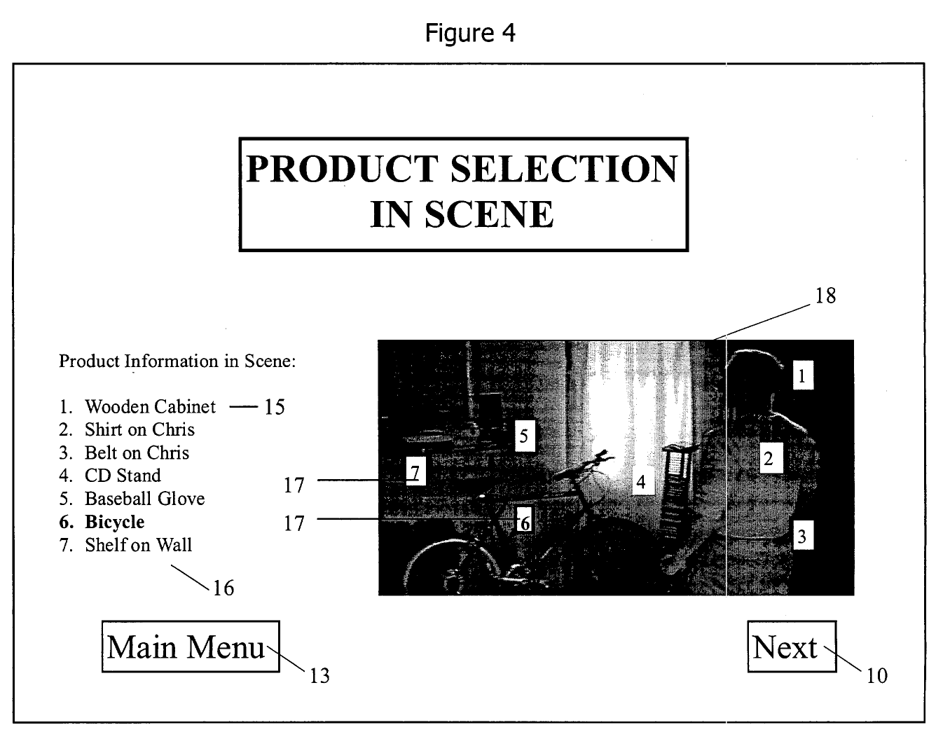

As shown in FIG. 1, upon being welcomed to the Catalog at the WELCOME SCREEN, the user clicks on NEXT button 10 which presents the user with the main PRODUCT SELECTION menu of FIG. 2. If the Interactive Catalog is on the same disc as the movie, a PLAY MOVIE button (not shown) can also be included on the Main Menu to begin (or return to) the movie. Once the PRODUCT SELECTION menu of FIG. 2 has been selected, choosing SELECT BY SCENE (for example by using the arrow or tab keys to highlight button 11 and then pressing the Enter key), results in navigation to the PRODUCT SELECTION BY SCENE submenu shown in FIG. 3 in which the user is presented with scene thumbnails 14 containing products used within the movie, Choosing a specific SCENE button 14 presents the user with the corresponding PRODUCT SELECTION BY SCENE display as shown in FIG. 4. The user can view additional SCENE buttons 14 by choosing NEXT button 10. Choosing MAIN MENU button 13 returns user to the main PRODUCT SELECTION menu of FIG. 2.

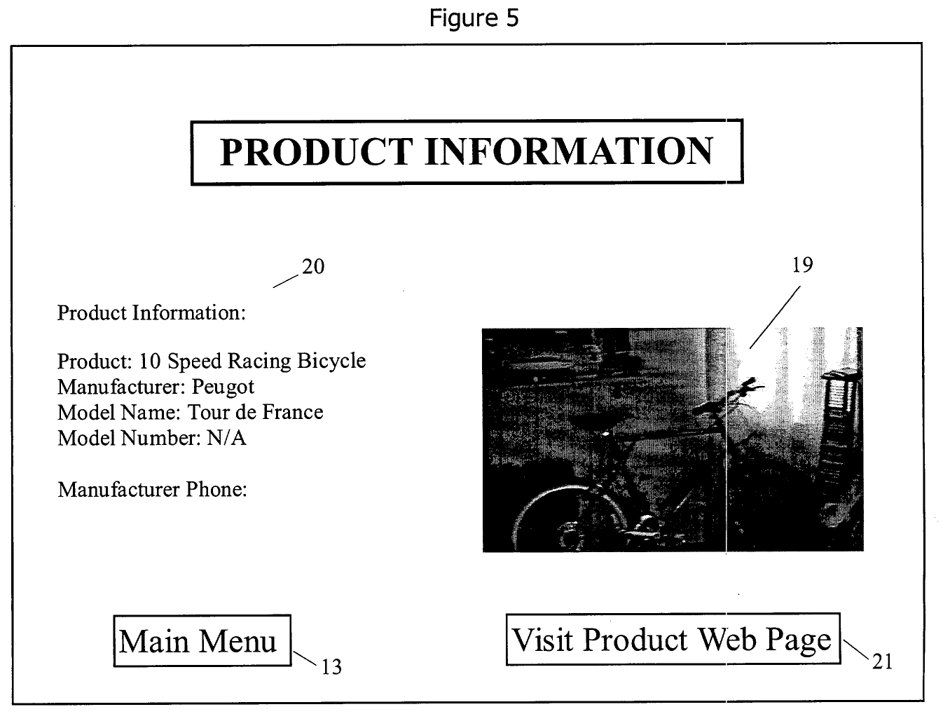

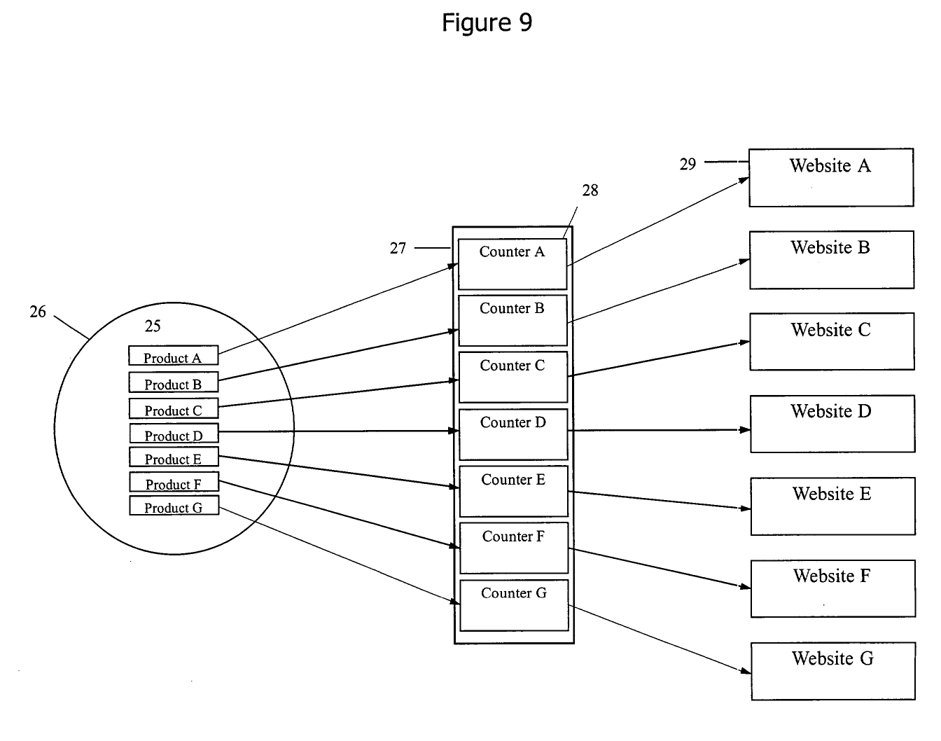

From the PRODUCT SELECTION BY SCENE display of FIG. 4, the user can choose a PRODUCT NAME button 15 from the PRODUCT INFORMATION IN SCENE list 16 corresponding to numerical identification 17 within the SCENE PICTURE 18. Choosing a PRODUCT NAME button 15 or numerical identification 17 presents the selected product's PRODUCT INFORMATION display as shown in FIG. 5. The user is presented a PRODUCT PICTURE 19 and a PRODUCT INFORMATION area 20 containing manufacturer/marketing information specific to the chosen product, and a VISIT PRODUCT WEBSITE button 21 to be used to buy the depicted product and/or access further product information from the Internet, as will be later described in more detail with reference to FIG. 9.

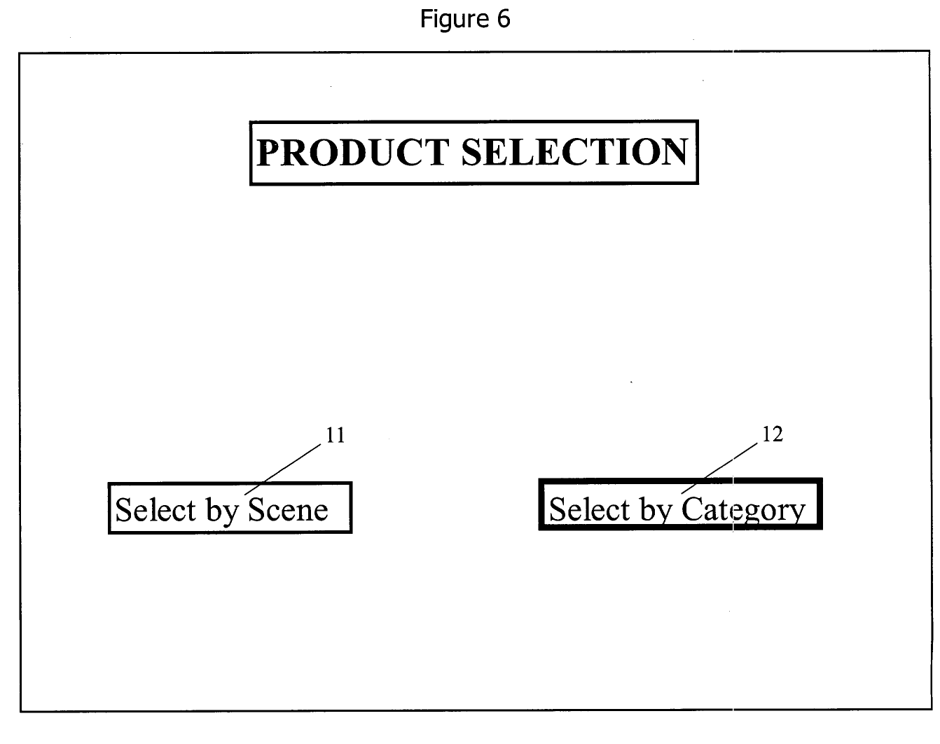

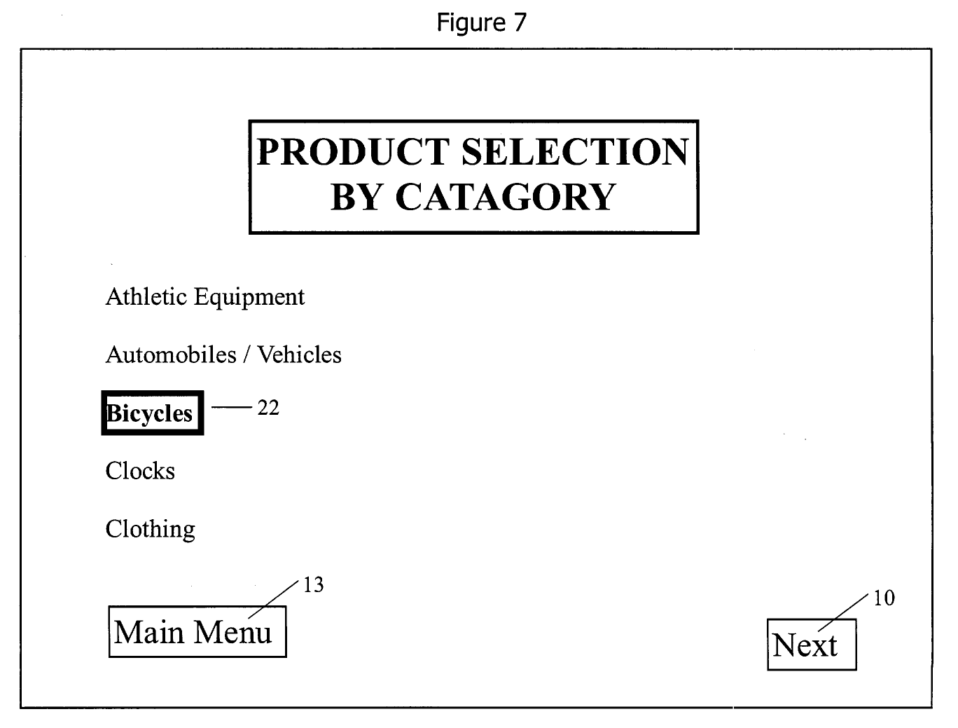

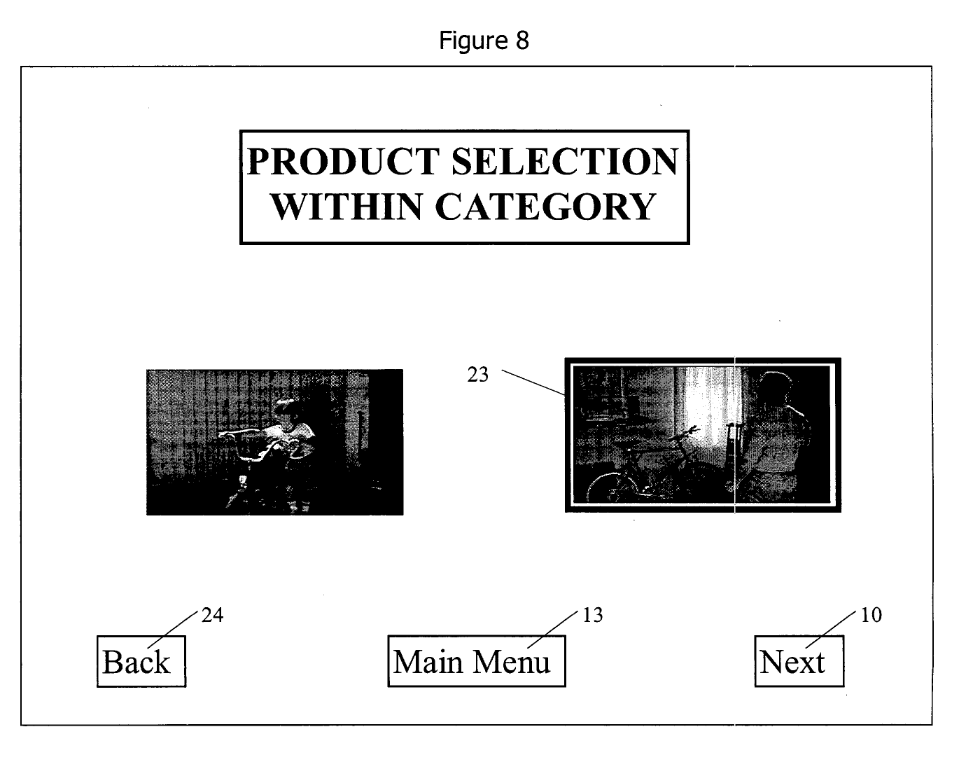

The user can also view the Catalog and access information about selected Featured Products by choosing SELECT BY CATEGORY button 12, which is shown highlighted in FIG. 6. Choosing SELECT BY CATEGORY button 12 presents the user with the PRODUCT SELECTION BY CATEGORY submenu shown in FIG. 7. The user can navigate over each available CATEGORY button, for example the highlighted BICYCLES button 22. Choosing a CATEGORY button 22 presents the PRODUCT SELECTION OF CATEGORY display shown in FIG. 8. The user can view and choose a desired product by selecting PRODUCT button 23. As described previously, the user can return to FIG. 2 by choosing MAIN MENU button 13, and can view additional PRODUCT buttons 23 by choosing NEXT button 10 or can review previous PRODUCT buttons 23 within the same PRODUCT CATEGORY by choosing BACK button 14. If there are no more products in that PRODUCT CATEGORY, NEXT button 10 can advance the User to the next category on the category list 26 and/or BACK button 24 can return the User to the previous category on list 26. Choosing a PRODUCT button 23 presents the selected product's PRODUCT INFORMATION display as has already been described with reference to FIG. 5.

The operation of the VISIT PRODUCT WEBSITE button 21 (FIG. 5) will now be described in more detail with reference to the connectivity flow chart of FIG. 9. In particular, choosing VISIT PRODUCT WEBSITE button 21 when viewing the PRODUCT display 25 (shown in more detail in FIG. 5) of CATALOG STORAGE MEDIA 26 from a DVD-compatible computer (or other DVD-compatible device with Internet access capability) links the user from CATALOG STORAGE MEDIA item 26 to an external TRANSFER LINK SERVER 27 which records each such user access attempt on a CLICK (HIT) counter 28 associated with that PRODUCT and directs the user to the corresponding MANUFACTURER'S PRODUCT WEBSITE 29.

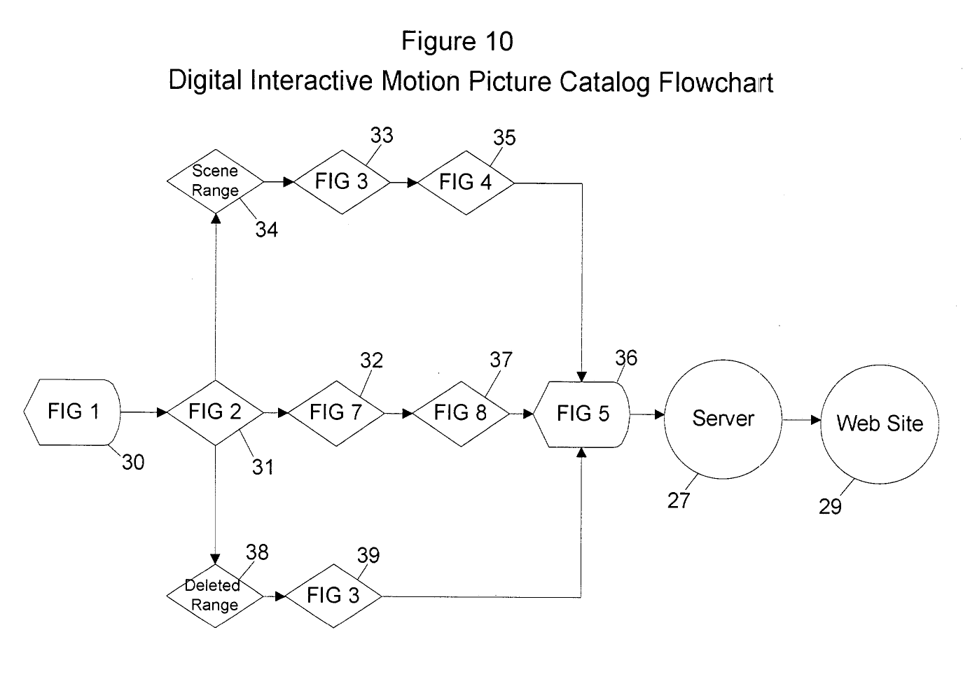

The overall organization of the Interactive Catalog is illustrated in FIG. 10. The Welcome screen 30 (FIG. 1) leads to a Main Menu 31 (FIG. 2). Main Menu 31 in turn branches into the previously described Selection by Category submenu (FIG. 7) or the previously described Selection by Scene submenu 33 (FIG. 3), the latter via an option intermediate Scene Range submenu 34, in the event the Interactive Catalog 26 includes so many different Scenes that it is not practical for the user to advance through all the Scene submenus (FIG. 3) by means of Next button 10. From the Product Selection by Scene submenu 33, the user advances to the Product Selection in Scene display 35 (FIG. 4) and then to the Product Information display 36 (FIG. 5). If instead the user has chosen to proceed via Product Selection by Category submenu 32, the user advances to the Selection of Product within Category submenu 37 (FIG. 8) and thence to the selected Product display 36.

Similarly, in the event the Interactive Catalog 26 includes products featured only in deleted scenes, or not otherwise readily identifiable in the movie, Main menu 31 may also include a branch to an alternate Range Selection submenu 38 leading to an alternative Product Selection submenu 39 (for example, a Product Selection by Scene menu similar to that of FIG. 3, but displaying only selected Deleted Scenes) which in turn leads to the selected Product Information display 36. A similar alternate submenu process may be used to include related products and services (for example, hotels, cruise ships, entertainment venues, designer goods, sporting goods, other entertainment productions and/or leisure and recreational activities) not actually featured in the movie, but having an ongoing relationship or sponsorship with the movie's producer, or otherwise intimately involved in the production.

Regardless of which branch is used to enter the Product Information display 36, the user may either merely make a note of the displayed information, or if the Catalog 26 is mounted on a device connected to the Internet, the user may use the Visit Product Web Page button 21 to link to an external Manufacturer's Webpage 29 via an Interactive Catalog Hyperlink server 27, as described previously with respect to FIG. 9.

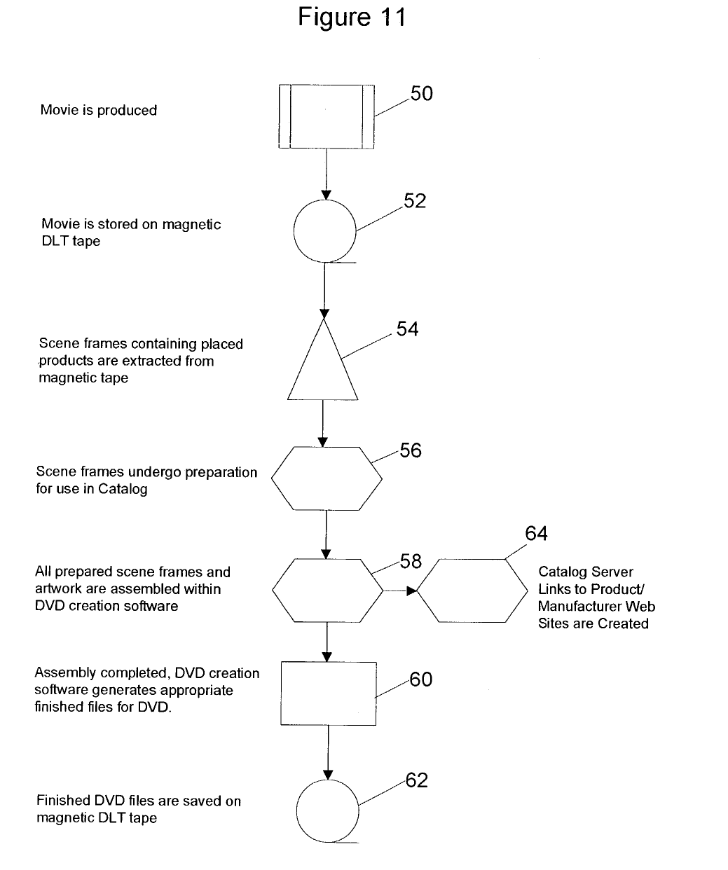

An exemplary process for creating an Interactive Featured Product Catalog will now be described with reference to FIG. 11. Once a movie (or television show, or other recorded event) has been produced (block 50) and a copy has been stored (block 52) on a suitable digital medium (such as DLT tape), scenes with one or more placed products are extracted (block 54) and cropped or otherwise edited (block 56) to highlight the featured product(s). Conventional DVD creation software may then be used to construct (block 58) the menu structure (FIG. 10) and place the previously edited frames into that structure (block 60), with the output of the DVD creation software being recorded (block 62) onto DLT tape or other suitable digital medium for subsequent distribution. If the Interactive Catalog 26 is to be Internet enabled, the server and internet links are defined and appropriate Internet hyperlinks are integrated (block 64) into the Product Information frames.

Two exemplary product placement methodologies will now described, one optimized for the Motion Picture Sector and the other for the Television sector. Those skilled in the art will doubtless realized that variations of the described technology may be used for specific projects and/or for other industry sectors. Moreover, although the described process assumes an interactive catalog that is created and distributed using digital editing and recording processes, and published in the form of tangible digital media (such as a Digital Versatile Disk), those skilled in the art will doubtless be able to adapt the described process to other modes of production and distribution.

The product placement process begins as in the prior art, with a concept/treatment/story board/script for an entertainment production, from which production designs (including casts, sets, costumes and other properties, special effects), schedules and budgets are formulated.

As part of the budgeting process, one aspect of breaking down a script is to determine what props, costumes, and locations are called for in the script and the cost impact they will have on the budget. The Product Placement department reviews the script and set design components to determine potential companies that can be approached for placing their products in the movie as props, etc thereby reducing the production cost and increasing the eventual profitability of the project. In particular, the product placement department can now approach manufacturers for any item/product called for in the script or used within the design of a set. Every product used in the creation of a movie, including those easily overlooked, for example—all floor coverings and all wall coverings (including paint)—are now potential product placement items.

Depending on the agreements made between the studio/production company and the manufacturers, agreed upon fees may be paid to the studio/production company prior to the theatrical release of the movie. The movie is made and released theatrically, and any agreed promotional campaigns or tie-ins are executed.

The initial theatrical release may be limited to the United States with release to foreign markets at a later time, or may be released domestically and internationally at the same time, with a subsequent re-release on video/DVD, pay-per-view, and other ancillary markets. Alternatively, the theatrical release may be skipped entirely, and with the movie be released directly to one or more of those ancillary markets. Although the video/DVD release of a movie may be advertised, often it is not, and the promotional campaigns and tie-in campaigns are non-existent because new promotional and tie-in campaigns are being waged at the theatrical release level for other new movies being released.

In the specific example of a movie that is released (or re-released) on DVD, a separate DVD disc containing the Digital Interactive Motion Picture Product Catalog created uniquely for that movie may be included in the DVD box for both sales and rental, that showcases the specific products placed in the accompanying movie. Alternatively, the catalog could be a separate track (or “Title”) on the same DVD as the movie, or could be published electronically over the internet at a website URL identified on the DVD or its packaging possibly with a hyperlink that automatically connects the viewer to the Interactive Catalog. A similar electronic publication approach could also be employed for movies that are distributed over cable on a pay per view basis, or even during the original theatrical release, especially for high budget productions that are promoted on a dedicated website. The website could be located by conventional means such as displaying the URL at the end of the movie or by making it available to search engines, or, if the viewer has selected the movie from an on screen menu, that same menu could direct the viewer to the corresponding product placement site.

Regardless of the medium and mode of distribution, the viewer/consumer is able to review the interactive catalog of products used and obtain enough pertinent information about the product(s), so as to empower the consumer to purchase said product(s) from a local vendor; or purchase the desired product(s) directly from the manufacturers' web site, provided the web site has the capability to allow consumers to purchase products through said web site.

As previously described with reference to FIG. 9, contained in the Digital Interactive Motion Picture Product Catalog for each product are unique Internet links that allow the consumer to directly interact with the product/manufacturer Internet web site. These links are active anytime the consumer viewing the Catalog DVD does so using any DVD device capable of Internet connectivity. These unique links contained in the Digital Interactive Motion Picture Product Catalog provide a means to track the amount of Internet traffic site by site, that is generated by persons using the Digital Interactive Motion Picture Product Catalog to access the product/manufacturer web site.

By including the interactive catalog with all the published videos featuring a particular movie, product information contained therein is readily accessible to prospective consumers for as long as the video rental stores stock that movie, and/or for as long as the video purchaser keeps that movie in his/her home collection. Similarly, the associated websites and links unique to that movie's product placements may be maintained for a prolonged period of time with only minimal maintenance costs, which will typically be absorbed by the manufacturers of the placed products. This affords the consumer the ability to conveniently review and get current information for any product used in the corresponding movie years after the movie's release, and affords the manufacturer an effective, abiding, focused impact per product for advertising dollars spent.

A similar procedure can be used in the television sector, at least for those shows which are subsequently released on video and DVD. When these shows are released to video/DVD for rent and for sale, the Digital Interactive Motion Picture Product Catalog creates a “backend” revenue stream that can be capitalized upon using product placement.

Accordingly, in the development phase of television programs, especially for those shows that are likely to be released to video/DVD, the product placement department can now approach manufacturers for any item/product called for in the script or used within the design of a set and plan for an eventual accompanying interactive catalog of placed products and services. Every product used in the creation of a television show, including those easily overlooked, for example—all floor coverings and all wall coverings (including paint)—are now potential product placement items.

Depending on the agreements made between the television studio/network and the manufacturers, agreed upon fees can be paid to the television studio/network prior to the broadcast release of the television show for inclusion of manufacturers' products in the Digital Interactive Motion Picture Catalog that will be released when the television show is released to video/DVD. This can be particularly beneficial to the television studio/television network for programs such as, but not limited to: mini-series (commercial television); mini-series (commercial cable/satellite television); mini-series (premium cable/satellite television)—and for ongoing series (commercial television), ongoing series (commercial cable/satellite television); ongoing series (premium cable/satellite television).

Alternatively, the interactive catalog can be located on an Internet website, linked not only to any subsequent video re-releases, but also to the original broadcast, for example by means of a hyperlink embodied in an interactive listing of television programs distributed by a cable operator, or via a sponsored link in an electronic program guide on the Internet.

What is claimed is:

1. A method for showcasing products placed in an entertainment production, comprising the steps
identify possible product placement candidates
negotiate with sources of identified products,
generate list of products to be featured in that production
finalize scripts, set designs and/or locations using a number of the featured products after production has been completed, generate an interactive catalog of featured products with links both to the production and to a source of each of the featured products, and
publish the interactive catalog

2. The method of claim 1 wherein the production links include a production still showing a particular featured product

3. The method of claim 2 wherein
one of the source links identifies a manufacturer or distributor of the particular featured product,

4. The method of claim 2 wherein
one of the sources link identifies a catalog retailer selling the particular featured product,

5. The method of claim 2 wherein
one of the source links identifies a retail outlet where the particular featured product may be inspected and purchased.

6. The method of claim 2 wherein
on of the source links is a hyperlink to an Internet website associated with the particular featured product

7. The method of claim 6 wherein
the negotiate step includes a provision for a payment based on interest in a featured product generated by the interactive catalog and
the hyperlink includes an internet server with a counter for counting the number of clicks on that particular hyperlink.

8. The method of claim 2 wherein
at least some of the production links are organized by scene

9. The method of claim 2 wherein
the interactive catalog is organized by product category

10. The method of claim 2 wherein
the interactive catalog includes featured products omitted from the final production release

11. The method of claim 10 wherein deleted scenes from the production are used to link the production to the omitted featured products

12. The method of claim 2 wherein
the interactive catalog includes supplemental submenus leading to goods and/or services not associated with particular scenes from the final production release.

13. The method of claim 2 wherein said goods and/or services include hotels, cruise ships, entertainment venues, designer goods, sporting goods, and/or recreational activities.

14. An interactive catalog of products featured in an entertainment production, comprising:
a first menu hierarchy for selecting products based on scenes from the production;
a second menu hierarchy for selecting products based on categories independent of the production; and
a separate product information display for each featured product,
wherein each said product information display includes a scene from the production and a hyperlink to an Internet website associated with that featured product.

15. The interactive catalog of claim 14, further comprising a third menu hierarchy for selecting featured products that were not visible in a final production release,

16. The interactive catalog of claim 15, wherein the product information display for a particular not visible product includes a deleted scene from the production in which that featured product was visible.
